(19) United States
(12) Patent Application Publication
(10) Pub. No.: US 2005/0174665 A1
(43) Pub. Date: Aug. 11, 2005

(54) Electrical current measurements at head-disk interface

(76) Inventors: Xiaofeng Zhang, Fremont, CA (US); Zhu Feng, Pleasanton, CA (US); Ellis T. Cha, San Jose, CA (US); Yen Fu, San Jose, CA (US)

Correspondence Address: KENYON & KENYON, Suite 600, 333 W. San Carlos Street, San Jose, CA, 95110-2711, US

(21) Appl. No.: 10/775,658

(22) Filed: Feb. 9, 2004

(51) Int. Cl. G11B 5/02

(52) U.S. Cl. 360/25

(57) ABSTRACT

According to an embodiment of the present invention, head/disk contact events are determined through a measurement of current at the head disk interface. For example, an ammeter/voltage source component may be electrically coupled to a magnetic/slider of a disk drive as well as to a spindle coupled to the recording medium. Applied voltage to the slider may result in a lower flying height. Greater measured current by the ammeter could indicate head/disk contact and assist in adjusting applied voltage to obtain a desire flying height.

### FIELD OF THE INVENTION

The present invention pertains to a method and apparatus for measuring current in hard disk drives and the like. More particularly, the present invention pertains to measuring electric current between a magnetic recording head and the recording medium.

### BACKGROUND OF THE INVENTION

Hard disk drives are common information storage devices essentially consisting of a series of rotatable disks that are accessed by magnetic reading and writing elements. These data transferring elements, commonly known as transducers, are typically carried by and embedded in a slider body that is held in a close relative position over discrete data tracks formed on a disk to permit a read or write operation to be carried out. In order to properly position the transducer with respect to the disk surface, an air bearing surface (ABS) formed on the slider body experiences a fluid air flow that provides sufficient lift force to “fly” the slider and transducer above the disk data tracks. The high speed rotation of a magnetic disk generates a stream of air flow or wind along its surface in a direction substantially parallel to the tangential velocity of the disk. The air flow cooperates with the ABS of the slider body which enables the slider to fly above the spinning disk. In effect, the suspended slider is physically separated from the disk surface through this self-actuating air bearing.

Some of the major objectives in ABS designs are to fly the slider and its accompanying transducer as close as possible to the surface of the rotating disk, and to uniformly maintain that constant close distance regardless of variable flying conditions. The height or separation gap between the air bearing slider and the spinning magnetic disk is commonly defined as the flying height. In general, the mounted transducer or read/write element flies only approximately less than a micro-inch above the surface of the rotating disk. The flying height of the slider is viewed as one of the most critical parameters affecting the magnetic disk reading and recording capabilities of a mounted read/write element. A relatively small flying height allows the transducer to achieve greater resolution between different data bit locations on the disk surface, thus improving data density and storage capacity. With the increasing popularity of lightweight and compact notebook type computers that utilize relatively small yet powerful disk drives, the need for a progressively lower flying height has continually grown.

As shown in FIG. 1 an ABS design known for a common catamaran slider 5 may be formed with a pair of parallel rails 2 and 4 that extend along the outer edges of the slider surface facing the disk. Other ABS configurations including three or more additional rails, with various surface areas and geometries, have also been developed. The two rails 2 and 4 typically run along at least a portion of the slider body length from the leading edge 6 to the trailing edge 8. The leading edge 6 is defined as the edge of the slider that the rotating disk passes before running the length of the slider 5 towards a trailing edge 8. As shown, the leading edge 6 may be tapered despite the large undesirable tolerance typically associated with this machining process. The transducer or magnetic element 7 is typically mounted at some location along the trailing edge 8 of the slider as shown in FIG. 1. The rails 2 and 4 form an air bearing surface on which the slider flies, and provide the necessary lift upon contact with the air flow created by the spinning disk. As the disk rotates, the generated wind or air flow runs along underneath, and in between, the catamaran slider rails 2 and 4. As the air flow passes beneath the rails 2 and 4, the air pressure between the rails and the disk increases thereby providing positive pressurization and lift. Catamaran sliders generally create a sufficient amount of lift, or positive load force, to cause the slider to fly at appropriate heights above the rotating disk. In the absence of the rails 2 and 4, the large surface area of the slider body 5 would produce an excessively large air bearing surface area. In general, as the air bearing surface area increases, the amount of lift created is also increased. Without rails, the slider would therefore fly too far from the rotating disk thereby foregoing all of the described benefits of having a low flying height.

As illustrated in FIG. 2, a head gimbal assembly 40 often provides the slider with multiple degrees of freedom such as vertical spacing, or pitch angle and roll angle which describe the flying height of the slider. As shown in FIG. 2, a suspension 74 holds the HGA 40 over the moving disk 76 (having edge 70) and moving in the direction indicated by arrow 80. In operation of the disk drive shown in FIG. 2, an actuator 72 moves the HGA over various diameters of the disk 76 (e.g., inner diameter (ID), middle diameter (MD) and outer diameter (OD)) over arc 78.

As the flying height of the slider decreases, interference between the slider ABS and the disk surface increases in frequency. This interference is often called “head-disk interference” (HDI). It includes both direct contact between the slider and the disk, and indirect contact through debris, lubricant, etc. on the disk surface. The greater the HDI, the more wear and tear on the slider and its ABS. HDI can damage the read-write head directly, or cause catastrophic failure by disabling the air bearing.

To combat the problems associated with HDI, a tolerance is set for the flying height of the slider. Thus, it is assumed that if the measured flying height of the slider is too low, then there will be too much HDI, adversely affecting the operation of the hard-disk drive. As stated above, however, the lower the flying height of the slider, the greater the data capacity for the drive.

One problem seen with using a flying height tolerance to control HDI is that as the flying height of conventional sliders is reduced, the tolerances become tighter. A typical flying height for a slider is a few nanometers. Variations in surface topography for the disk and slider, vibration in both surfaces, and debris/lubricant accumulating, migrating, and dropping off both surfaces add complexity to the measurement of flying height at any particular time.

As sliders have become smaller and smaller, it becomes more difficult to include traditional spacing transducers such as capacitance probes, photonic probes, etc. Furthermore, testing the flying height of a slider over a transparent disk as is known in the art causes additional problems. Since the transparent disk and the magnetic disk used in the drive differ in mounting conditions, disk roughness, and electrostatic attraction caused by “tribo-charging,” the measure of flying height over the transparent disk may not correlate to the flying height over the magnetic disk. Also, the measurement resolution of the flying height at such a low flying height can be very poor, and measurement of flying height over the transparent disk can cause contamination of the slider or electrostatic discharge (ESD) damage.

Since flying height varies over particular areas of the slider, it has been suggested to measure flying height over a very small region of the air bearing surface. For example, “magnetic spacing” would be the space directly under the read-write head and may be measured by analyzing the read-back signal from the read-write head. During measurement of the magnetic spacing, the disk speed, air pressure, gas composition in the slider-disk interface is controlled to reduce the flying height of the slider. Flying height may also be reduced by applying a DC voltage across the slider-disk interface. The change in magnetic spacing can be calculated e.g., using the Wallace equation. Thus, a slider that can have its magnetic spacing reduced by a significant amount is presumed to have an adequate flying-height margin. To implement this method of measuring magnetic spacing requires relatively expensive equipment and does not guarantee that other parts of the slider have impacted the disk.

Rather than inferring the flying height of the slider, some methods known in the art attempt to detect the HDI directly. For example, friction between the slider and disk can be measured by either a strain-gauge or by motor power consumption. Slider-disk impact can be measured from the acoustic emission of the slider or by a piezo-electric sensor. Perturbation of the slider position relative to the disk can be detected through amplitude, frequency, or phase modulation in the read-back signal. The equipment needed to measure these parameters can be expensive and may not be able to detect mild head-disk interference. One other method for HDI detection is to detect temperature changes in the read-write head. As with the magnetic spacing measurements described above, the only area being monitored is the read-write head, and other areas on the slider may impact the disk.

As is known in the art, as the flying height of the slider is lowered, the recording track density and overall data capacity of the magnetic medium is increased. In current drives, the flying height of the slider is on the order of less than 10 nm (nanometers). Because of this low separation distance between the head slider and the disk, head-disk contacts are unavoidable. Head-disk contact events may lead to read/write errors, head slider damage, disk damage, and general disk drive failure.

To minimize head-disk contacts in normal disk drive operation, it is mandatory to control the flying height, the surface roughness of the slider and the media, and the amount of particulate contaminants. For magnetic disks, a glide test is performed to screen out disks with excessive surface protrusions or particles. A piezo-electric (PE) sensor or an acoustic emission (AE) sensor is mounted on a glide head to detect head-disk contract when the glide head hits a particle deposited on the disk. A critical factor to this technique is calibration of the testing apparatus. To do so, typically requires that the glide head be used over a disk medium having a known topography. The signal produced by the glide head is based on protrusion (or bump) height and instrument gain.

There are several problems using the glide head of the prior art. First, the geometry of real particles and protrusions on a magnetic disk tend to be different than the known topography of the calibration disk (for example, the bumps on the magnetic disk may have a larger lateral dimension when compared to the bumps on the calibration disk even though they have the same height). This leads to a calibration signal which may underestimate the energy present during an actual head-disk contact event in a real drive (leading to missed head-disk contact events or a higher glide yield). Second, the PE or AE sensor can sometimes be excited by air-bearing resonance in the slider. Thus, a head-disk contact event may be detected in such a situation when no such event occurred.

Though it is important to control the surface roughness of the air-bearing slider to minimize head-disk contact events, sliders may not be tested for this feature. This is due, in part, to the possibility of electro-static shock discharge (ESD) damaging the slider during the test. In such a case, only a small number of sliders will be used to test for this feature as a sample of other devices. All magnetic heads, however, are tested for magnetic and electrical performance (e.g., with Dynamic Electrical Tests (DET)). The DET test, however, cannot be readily used for detecting head-disk contact due to surface protrusion or the presence of particles on the slider head.

Head-disk contact events can also be measured by monitoring the electrical performance of the magnetic head or acoustic emission of the magnetic head. As to the electrical performance of the head, the equipment necessary to measure the electrical signal is external to the disk drive. As to acoustic emission, as described above, air bearing resonance can interfere with the accuracy of the measurements.

In view of the above, there is a need for an improved method and apparatus for detecting head-disk contact events.

### SUMMARY OF THE INVENTION

According to an embodiment of the present invention, electrical current is measured at the interface between the magnetic head slider and the magnetic medium. The presence of current between the medium (e.g., a magnetic recording disk) and the head slider is due to the presence of charge on the slider and disk and a discharge takes place during contact between the two. Such a current may also be due to triboelectric charge and discharge due to a head-disk contact event. This discharge current is very low and can be on the order of microamps or nanoamps. The measurement of the electrical current between the medium and the slider-head provides an accurate assessment of slider/disk contact events allowing the determination of the true glide or glide avalanche point of a disk and to identify magnetic head sliders that are contaminated (e.g., debris on the air bearing surface) are have flying heights that are too low for efficient operation.

### BRIEF DESCRIPTION OF THE DRAWINGS

FIG. 1 is a perspective view of a flying slider with a read and write element assembly having a tapered conventional catamaran air bearing slider configuration.

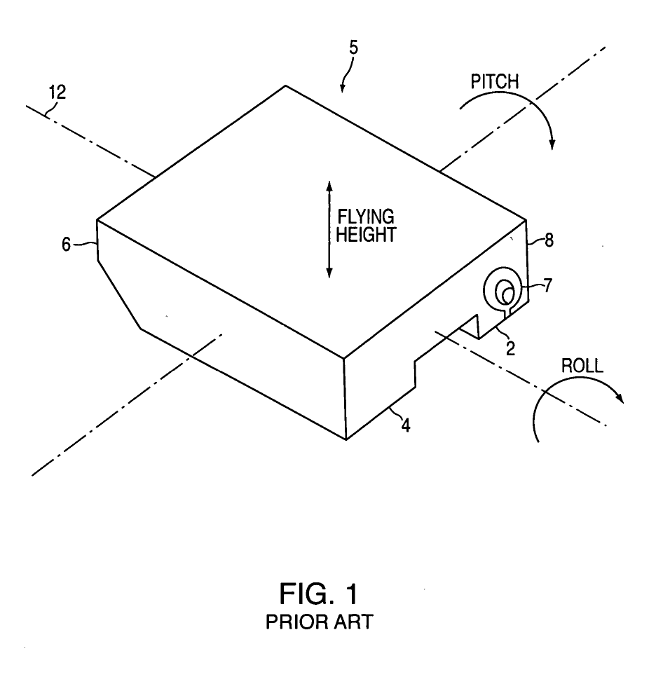

FIG. 2 is a plan view of a mounted air bearing slider over a moving magnetic storage medium.

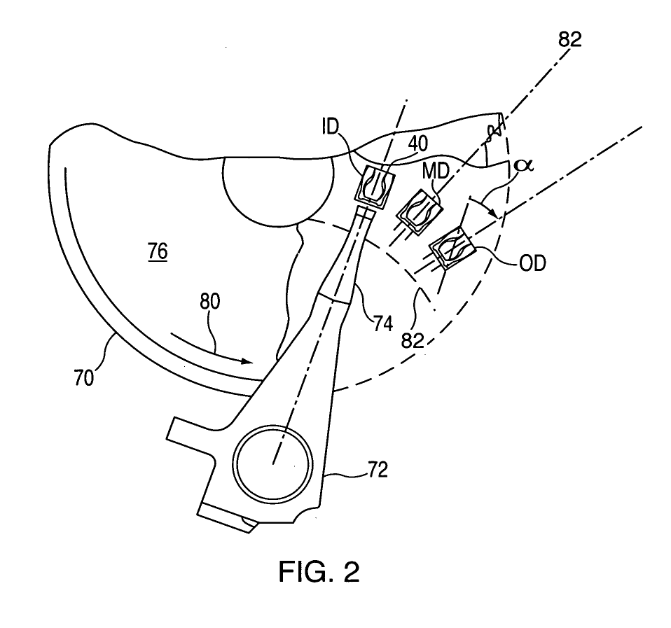

FIG. 3 is a block diagram of a system for measuring electric current between a magnetic head and a magnetic recording medium according to an embodiment of the present invention.

FIG. 4 is a graph comparing HDI current measurement according to an embodiment of the present invention with acoustical energy measurement of the prior art.

FIG. 5 is a graph comparing a PW50 signal from a slider/head and a HDI current measurement for the slider/head according to an embodiment of the present invention.

FIG. 6 is a graph comparing HDI current measurement according to an embodiment of the present invention with acoustical energy measurement of the prior art.

### DETAILED DESCRIPTION

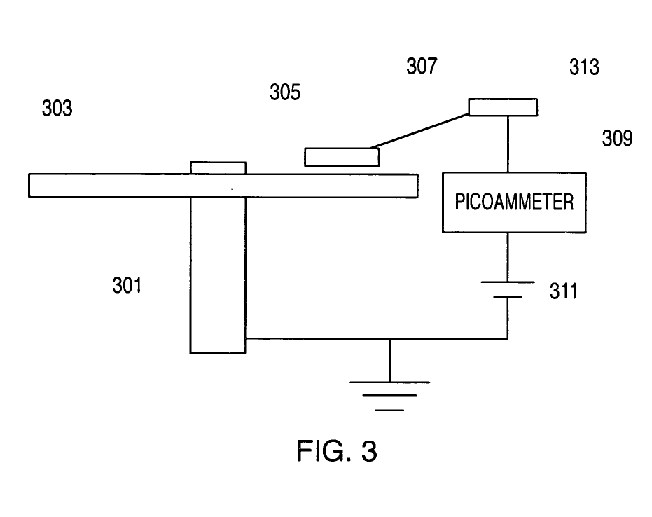

Referring to FIG. 3, an apparatus for measuring electrical current at a head disk interface is shown. As with a conventional disk drive, a magnetic recording medium (e.g., magnetic recording disk 303) is provided that is rotated by spindle 301. In this example, the disk 303 is clamped to the spindle 301 and electrically grounded. A head (e.g., magnetic recording head 305) is provided with an air bearing surface so that it flies above the moving surface of the disk. A current measurement apparatus is provided, such as a picoammeter (e.g., a model 6487 picoammeter/voltage source manufactured by Keithley Instruments, Inc., Cleveland, Ohio).

In a first embodiment of the present invention, the head gimbal assembly (HGA, including the head 305 and its supporting flexure) is electrically isolated from ground. The ammeter 309 would be connected to contact 313 which is electrically connected over suspension 307 to the magnetic recording head. As seen in FIG. 3, if the HGA is electrically isolated from ground, then the ammeter 309 would detect electric current flowing between the disk and the head, such as would occur during contact events.

In a second embodiment, the ammeter 309 is coupled to the slider 305 through a wire separate from the suspension 307 (not shown specifically in FIG. 3). Again, the recording head/slider is electrically isolated from ground, and the ammeter 309 would measure current between the head 305 and the recording medium 303. This embodiment may provide a lower capacitance and, thus, more sensitivity to the current measurement.

In the embodiments above, the model 6487 picoammeter/voltage source is amenable to measure a somewhat constant low-level current, such as one that may be seen for multiple head-disk contact events each revolution. The model 428 current amplifier by the same manufacturer may be better for situations where the current is more transient (e.g., due to contact between the head and a particle on the disk).

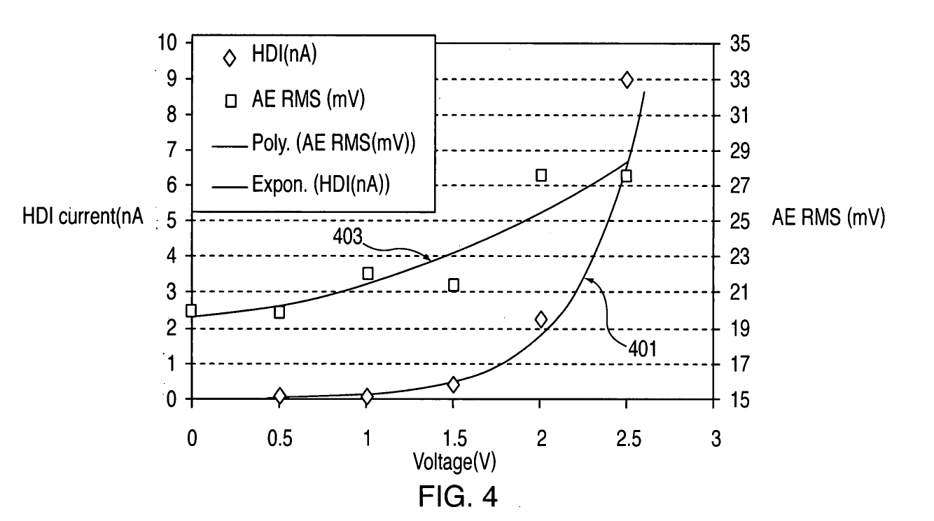

Whether to use a bias voltage in the measurement of current between the head/slider and the disk depends on the flying height and the nature of the head-disk contacts as described above. For example, in an environment where multiple head-disk contact events occur each revolution of the disk, the model 6487 picoammeter is used, which applies an external voltage of 0 to 2 volts, depending on the spacing between the head/slider and the disk. Referring to FIG. 4, a typical head-disk interface current measurement result is shown. In FIG. 4, the bottom line 401 represents current through the head disk interface in nanoamps as seen by the Y-axis indication on the left of the graph The X-axis refers to applied voltage to the HDI measured in volts. As applied voltage increases, the HDI current rises in an approximately exponential (Expon.) manner. The top line 403 represents the Acoustic Energy root-mean-square (RMS) measured in millivolts as seen by the Y-axis indication on the right of the graph. It can be readily seen that the AE measurement is somewhat scattered, indicating less sensitivity to head-disk contact events. It is noted that as the applied voltage increases, the flying height of the slider decreases and the number of head-disk contact events increases resulting in an increase in the HDI current.

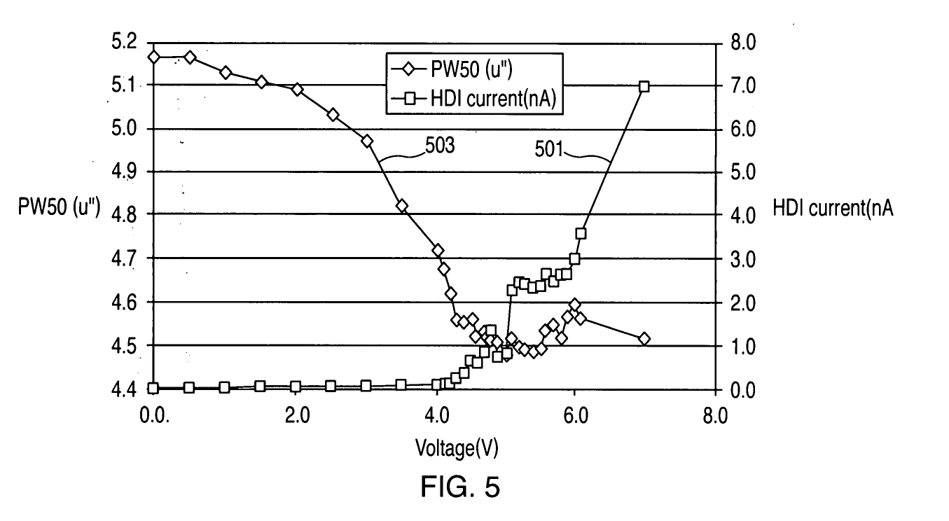

Referring to FIG. 5, a graph showing the relationship of applied voltage and HDI current is shown. In the first line, line 501, the HDI current in nanoamps is plotted versus the applied voltage in volts. The second line, line 503, shows the read signal strength from the slider head versus applied voltage. In this example the read signal strength is represented as microinches (u″) and is related to the pulse width at 50% peak height (PW50). The PW50 signal decreases with increased applied voltage. It is noted that in this example, the PW50 signal appears to plateau at approximately 4.5 volts. It is also noted that the HDI current appears to increase dramatically at this point as well. The indication is that the head slider is in contact with the disk at this point.

The interaction between the head slider and the disk may be modeled as a quasi-parallel capacitor. The attractive force, f, between the disk and the head slider can be represented as follows:

$$f = \frac{k {V}^{2}}{{d}^{2}} \qquad ( Eq . 1 )$$

where k is a constant, V is the applied voltage, and d is the head/slider to disk spacing. From Eq. 1, increased applied voltage results in a greater force of attraction between the head/slider and the disk; the distance, d, becomes lower to compensate. Head-disk contact events occur, as described above, due to asperities on the head/slider and/or disk. When contact occurs, there is a discharge current, and this current increases and the contact area and/or the number of contacts increases.

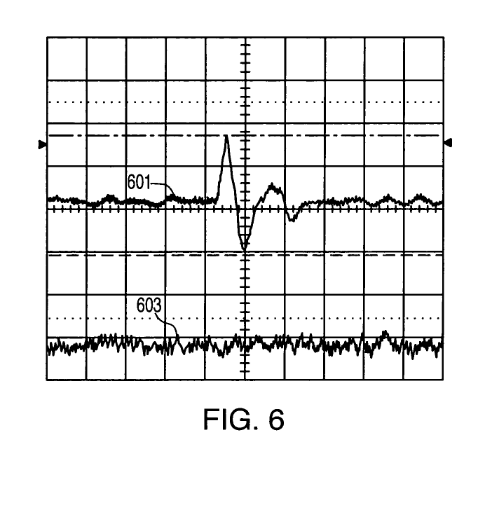

As stated above, for intermittent head-disk contacts, the transient current may be measured using a current amplifier (e.g., a Keithly 428 current amplifier). In FIG. 6, the top line 601 represents a transient current where the head slider has flown over a particle on a magnetic disk. The bottom line 603 represents an acoustic emission over the same time window. As seen in FIG. 6, the transient current shows a spike indicating the presence of the particle. In this example, the time window is 10 μs and the current amplitude is 29 μA.

There are a variety of applications that may effectively use the HDI current measurement of the present invention. For example, in Dynamic Electrical Tests (DET) that are used to measure magnetic performance, the HDI current measurement can characterize which slider/heads have a flying height that is too low. In such a case, excessive HDI current could be an indication that the design of the air bearing surface for the slider/head does not provide a high-enough flying height.

As described above, glide tests are used to measure surface protrusions or particles. In a given magnetic disk revolution, if there are several “hits,” the average current at the HDI may be used to determine a glide avalanche point. As shown in FIG. 6, the HDI current measurement system can be more sensitive than standard acoustic emission measurements in glide test.

Measurement of HDI current may also be used to test a disk drive after assembly. HDI may be used to measure head/disk contact events in different operating environments for the disk drive (e.g., at normal ambient pressure and at high-altitude ambient pressure. HDI current measurement may also be used to detect head disk contact events when the slide/head is loaded or unloaded from the disk (e.g., using a ramp). Also, the performance of the drive during mechanical shock can be tested by monitoring head disk contact events via HDI current measurement.

While the present invention has been described with reference to the aforementioned applications, this description of the preferred embodiments is not meant to be construed in a limiting sense. It shall be understood that all aspects of the present invention are not limited to the specific depictions, configurations or dimensions set forth herein which depend upon a variety of principles and variables. Various modifications in form and detail of the disclosed apparatus, as well as other variations of the present invention, will be apparent to a person skilled in the art upon reference to the present disclosure. It is therefore contemplated that the appended claims shall cover any such modifications or variations of the described embodiments as falling within the true spirit and scope of the present invention.

For example, with respect to FIG. 3, the electrical connections for the slider may be provided on the existing printed circuit board (PCB) of the disk drive. As shown in FIG. 5, with increasing applied current, the flying height of the head/slider decreases. With measurement of the HDI current as a feedback signal, the applied current, and thus, the flying height of the slider can be adjusted as appropriate. Once the amount of applied current is ascertained, such would be applied to the slider (e.g. via the PCB of the disk drive) during normal operations. Taking this into account, the applied current may be different depending on the environment in which the disk drive will be used.

1. An apparatus, comprising:
a current measurement device;
a head gimbal assembly including a head to at least one of read and write information signals from/to a moving storage medium, said current measurement device electrically coupled to said head and said storage medium; and
said current measurement device is to measure current between said head and said storage medium.

2. The apparatus of claim 1 wherein said head is a magnetic head/slider.

3. An apparatus to measure contact between a magnetic recording head and a storage medium, comprising:
a current measurement device;
a head gimbal assembly including a magnetic recording head, said recording head electrically coupled to said current measurement device; and
a storage medium coupled to said current measurement device; and
said current measurement device to measure current between said magnetic recording head and said storage medium.

4. The apparatus of claim 3 wherein said storage medium is a rotating magnetic storage disk.

5. The apparatus of claim 4 wherein said magnetic storage disk is coupled to a spindle and said spindle is coupled to said current measurement device.

6. The apparatus of claim 5 wherein said current measurement device is a current amplifier.

7. The apparatus of claim 5 wherein said current measurement device is an ammeter/voltage source.

8. The apparatus of claim 7 wherein said ammeter/voltage source is to supply voltage to said magnetic recording head.

9. A method of measuring current, comprising:
coupling a current measurement device to a head of a head gimbal assembly, said head to at least one of read and write information signals from/to a moving storage medium;
coupling said current measurement device to a said storage medium; and
measuring current between said head and said storage medium with said current measurement device.

10. The method of claim 9 wherein said head is a magnetic recording head/slider and said storage medium is a magnetic storage disk.

11. The method of 10 wherein said magnetic storage disk is coupled to a spindle and said current measurement device is coupled to said spindle.

12. The method of claim 11 wherein said current measurement device is a current amplifier.

13. The method of claim 11 wherein said current measurement device is an ammeter/voltage source.

14. The method of claim 13 further comprising:
applying voltage to said magnetic recording head with said ammeter/voltage source.

15. A method of determining flying height characteristics for a disk drive comprising:
coupling a current measurement device to a head of a head gimbal assembly, said head to at least one of read and write information signals from/to a moving storage medium;
coupling said current measurement device to a said storage medium;
measuring current between said head and said storage medium with said current measurement device; and
determining that said head is defective based on said current measurement.

16. A method of determining glide height characteristics for a disk drive comprising:
coupling a current measurement device to a glide head of a head gimbal assembly;
coupling said current measurement device to a said storage medium;
measuring current between said head and said storage medium with said current measurement device; and
determining presence of disk asperities based on said current measurement.

17. A method of controlling flying height of a magnetic head in a disk drive comprising:
coupling an ammeter/voltage source to the magnetic head of a head gimbal assembly;
coupling said ammeter/voltage source to a rotating magnetic storage medium;
applying voltage to said magnetic head;
measuring current between said head and said storage medium with said ammeter/voltage source; and
adjusting an amount of applied voltage to said magnetic head based on said measure current.
